(19) United States
(12) Patent Application Publication
(10) Pub. No.: US 2024/0123455 A1
(43) Pub. Date: Apr. 18, 2024

(54) NEGATIVE HIGH VOLTAGE ELECTROSTATIC LUBRICANT FILTRATION MINIATURIZATION CONFIGURATION

(71) Applicant: ELF Holding Company LLC, Stillwater, MN (US)

(72) Inventors: Peter Lawrence Woods, Grimsby (CA); Chase Andrews Rickson, White Bear Lake, MN (US); James Kevin Rickson, Stillwater, MN (US)

(21) Appl. No.: 18/530,154

(22) Filed: Dec. 5, 2023

Related U.S. Application Data
(63) Continuation-in-part of application No. 17/202,196, filed on Mar. 15, 2021, now Pat. No. 11,878,310.
Application No. 17/202,196 is a continuation of application No. 15/894,167, filed on Feb. 12, 2018, now Pat. No. 10,946,392.

(51) Int. Cl. B03C 5/02; C02F 1/00

(52) U.S. Cl. CPC B03C 5/026; C02F 1/001; C02F 2201/006; C02F 2201/009; C02F 2303/06; C02F 2303/22

(57) ABSTRACT

Certain exemplary aspects of the present disclosure are directed towards an apparatus for electrostatic fluid filtration. The apparatus utilizing a negative probe electrode and a positive cylinder electrode in conjunction with filter media to filter contaminants from a fluid flow.

### RELATED APPLICATIONS

This application is a continuation-in-part of U.S. patent application Ser. No. 17/202,196, filed on Mar. 15, 2021, which is a continuation of U.S. patent application Ser. No. 15/894,167, filed Feb. 12, 2018, now U.S. Pat. No. 10,946,392, issued Mar. 16, 2021, the contents of which are hereby incorporated herein by reference.

### FIELD OF THE INVENTION

Embodiments described herein provide for the electrostatic filtration of contaminants from a continuous flow of dielectric liquids, especially, although not exclusively, lubricating oil and hydraulic fluids employed in association with turbines.

### BACKGROUND OF THE INVENTION

The operation of turbines and hydraulic systems, especially those used in utility-scale power generation, requires the use of lubricants which must be continuously monitored and maintained. These lubricants must be periodically cleaned or replaced in order to maintain the mechanical system's integrity. This holds true for many mechanical application, including but not limited to, marine vessels, aircrafts and drone, plastic injection molding, computer server dialectic medium and robotics.

Failure to properly maintain a system's lubricant may lead to the buildup of soluble varnish, water, or sub-micron contaminants of foreign particles that can change the extremely high tolerances of critical components leading to excessive ware and, potentially, catastrophic failure. The buildup of varnish, water, or other contaminants in a lubricant may contribute to excessive wear and eventual system failure by altering frictional characteristics of surfaces, increasing turbulence in lubricant flow (thereby decreasing efficiency and/or increasing operating temperature), or contributing to lubricant imbalance whereby oil degradation is accelerated, leading to additional contaminant propagation.

A problem particularly prevalent in commercial turbines is varnish buildup. Varnish buildup occurs when small contaminant particles are generated by the metal-on-metal friction of the movement of the turbine blades, bushings, and bearings. These contaminant particles then enter the lubricating oil of the turbine, and stick to the turbine's internal components, creating undesirable varnish that will impact the reliable operation of the turbine.

Regularly scheduled maintenance or unexpected shutdowns of systems may be extremely costly, and lead to extended downtime, decreasing output, which further increases the cost of system downtime, to say nothing of the opportunity cost due to the loss of revenue from power that is not being produced during downtimes, where scheduled or not. In many cases this “Opportunity Cost” can far exceed the entire cost of the Electrostatic Lubricant Filtration process.

### SUMMARY OF THE INVENTION

Various example embodiments are directed to apparatuses, systems, and related methods involving electrostatic fluid filtration suitable for removing insoluble contaminants known to produce undesirable varnish and sludge in non-conductive fluids (e.g., dielectric fluids). The electrostatic fluid filtration apparatus removes contaminants and may remove trace amounts of water from the fluid.

Various embodiments of the present disclosure are directed to an apparatus comprising: a conductive housing, a plurality of positive electrodes, and a plurality of negative electrodes alternately disposed between the positive electrodes within the conductive housing. Alternatively, the Electrostatic filter may be configured with a single “Probe” emitter surrounded by a cylindrical “Tube” collector. The electrostatic zone or field appears to be stronger with this configuration, although more localized and probably more effective with smaller reservoirs. Each alternately disposed pair of positive and negative electrodes form an electrostatic field between each of the positive and negative electrodes in response to the negative electrodes receiving a negative voltage. The electrostatic field places a charge on contaminants as the fluid flows through the electrostatic corona extending between the positive and negative electrodes cause the contaminants from the fluid to adhere to the collector plates or tubes, depending upon the design. The removable filter cartridge including a filter media extending between each of the positive and negative electrodes within the conductive housing removes additional contaminants from a fluid flow extending between the positive and negative electrodes. A power supply, electrically coupled to the negative electrodes, or emitter probe, transmits the negative voltage to the negative electrodes, or the emitter probe, depending on the configuration. Similarly, the conductive housing and the positive electrodes are electrically coupled to one another to form an electrical ground.

In more specific embodiments, the plurality of positive and negative electrodes are flat and maintain a specified spacing as to result in the strongest and most consistent electrostatic field (spacing subject to scale). Alternatively, the emitter is an aluminum probe powered by the negative voltage and the stainless steel tube surrounding it serves as the collector with a foam medium filling the void in between.

One or more of these embodiments may be particularly applicable, for example, to fluid contamination, and may more particularly relate to the removal of contaminants from common fluids, including non-conductive fluids and/or dielectric fluids. Such removal of contaminants will allow for the prolonged use or recycling/reuse of such fluids.

Various example embodiments are directed to a system for removing insoluble contaminants from a non-conductive and/or dielectric fluid. The system comprising an electrostatic fluid filtration device, a power supply, a fluid flow pump and sensor, a contaminant sensor, pressure and vacuum transducers, water sensor and controller circuitry and software. The electrostatic fluid filtration device includes a conductive housing, a plurality of positive electrodes, or a collector tube, a plurality of negative electrodes, or an emitter probe, and a removable filter cartridge. The plurality of negative electrodes, or emitter probe, is alternately disposed between the positive electrodes, or collector tube, within the conductive housing. Each alternately disposed pair of positive and negative electrodes form an electrostatic field between each of the positive and negative electrodes in response to the negative electrodes receiving a negative voltage. The electrostatic field acts on contaminants within a fluid flow extending between the positive and negative electrodes to filter the contaminants from the fluid. The conductive housing and the positive electrodes are electrically coupled to one another to form an electrical ground. The removable filter cartridges includes a filter media extending between each of the positive and negative electrodes within the conductive housing. The filter media removes additional contaminants from a fluid flow extending between the positive and negative electrodes. The plurality of positive and negative electrodes and the conductive housing direct the flow of fluid within the conductive housing axially in response to a first electrostatic field between a first pair positive and negative electrodes with a first electrical charge. The plurality of positive and negative electrodes and the conductive housing further direct the flow radially outward toward the outer wall of the conductive housing in response to the next electrostatic field between the next pair of positive and negative electrodes with the electrical charge different then the first electrostatic field. The negative power supply electrically coupled to the plurality of negative electrodes, or probe as the case might be, and the positive electrodes electrically, or the collector tube, coupled to one another and the conductive housing to create a ground produce a series of alternating electrostatic fields between each pair of electrode (number of fields are scalable). The fluid flow pump coupled to an inlet of the conductive housing directs a flow of fluid into the electrostatic fluid filtration device. The contaminant sensor, coupled to the inlet and/or an outlet of the conductive housing, detects the contaminant level of the fluid flowing past the contaminant sensor. The controller circuitry and software receives data from the fluid flow sensor indicative of a fluid flow rate, data from the contaminant sensor indicative of fluid contaminant level, data from the pressure and vacuum transducers, data from the water sensor, and data indicative of an output of the power supply. This data is reported and analyzed to determine filter life.

It is an object of the present invention to provide an electrostatic filtration apparatus and method for removing particulate contaminants from a dielectric fluid.

Therefore, an electrostatic filtration apparatus is provided for use in various settings where particulate contaminants may accumulate in a dielectric liquid, especially lubrication, turbine oils, hydraulic, and mineral oil liquids is disclosed herein. Said electrostatic filtration apparatus can be particularly suited for filtration of contaminants of sub-micron size where traditional mechanical and/or membrane filters are ineffective. Said electrostatic filtration apparatus can be configured to deploy an electrostatic field between a negatively charged emitter probe and a positively charged collector cylinder, which acts upon a target dielectric liquid flow. The target dielectric liquid flows through the electrostatic field, which negatively charges contaminant particles within the dielectric liquid flow, causing the contaminants to be attracted to the positively charged collector cylinder. The negatively charged contaminants then attach to the positively charged collector cylinder and are thereby eliminated from the dielectric liquid flow.

An electrostatic filtration apparatus according to an embodiment of the invention may be run continuously on a target dielectric liquid flow, allowing a target dielectric liquid to be cleaned and maintained without the need for maintenance shutdowns. The continuous running of the electrostatic filtration apparatus also means that the apparatus may achieve high levels of filtration over time, even where the apparatus may only achieve relatively low removal rates on any one pass-through of the target dielectric liquid. Major advantages of the continuous running of the electrostatic filtration apparatus include obviating the need for extended system downtime to maintain or clean the system's lubricant, increased lifespan of the lubricant, and increased operating efficiency of the lubricant as contaminants are removed over time.

An electrostatic filtration apparatus according to an embodiment of the invention may effectively remove contaminants from an external system (like a turbine) that already includes a high buildup of pre-existing varnish. As the electrostatic filtration apparatus removes contaminants from the lubricant passed through it, the increasingly clean lubricant will begin to remove varnish from the external system as it passes through the system, which will then be filtered from the lubricant as it passes through the electrostatic filtration apparatus. In this way, the electrostatic filtration apparatus may reduce maintenance requirements for systems even when those systems already contain high levels of contaminants or varnish when the electrostatic filtration apparatus is introduced.

An electrostatic filtration apparatus according to an embodiment of the invention may contain sensors that measure, for example, pressure, vacuum, relative humidity, voltage, amperage, run time, filter life, and ISO particulate ratings. These sensors may transmit their measurements via Modbus, or similar communications protocol, such that the measurements may be accessed by a user and used for, among other things, system performance analysis or predictive analysis of maintenance requirements.

The above discussion/summary is not intended to describe each embodiment or every implementation of the present disclosure. The figures and detailed description that follow also exemplify various embodiments.

### BRIEF DESCRIPTION OF THE DRAWINGS

Various example embodiments may be more completely understood in consideration of the following detailed description in connection with the accompanying drawings, in which:

FIGS. 1A-1I are isometric views of an electrostatic cartridge apparatus, consistent with various aspects of the present disclosure;

FIG. 2A is a top view of an electrostatic fluid filtration system, consistent with various aspects of the present disclosure;

FIGS. 2B-2C are cross-sectional side views of the electrostatic fluid filtration system of FIG. 2A, consistent with various aspects of the present disclosure;

FIG. 3A is a side view of an insulated high voltage module, consistent with various aspects of the present disclosure;

FIG. 3B is a cross-sectional side view of the insulated high voltage module of FIG. 3A, consistent with various aspects of the present disclosure;

FIG. 4 is a top view of a positive electrode of an electrostatic cartridge apparatus, consistent with various aspects of the present disclosure;

FIG. 5 is a top view of a negative electrode of an electrostatic cartridge apparatus, consistent with various aspects of the present disclosure;

FIG. 6 is a top view of a top ground electrode of an electrostatic cartridge apparatus, consistent with various aspects of the present disclosure;

FIG. 7 is a front view of an electrostatic liquid filtration system, consistent with various aspects of the present disclosure;

FIG. 8 is an Electrostatic Filtration Tank, consistent with various aspects of the present disclosure;

FIG. 9 is a Filter Cartridge Top CPVC Plate, consistent with various aspects of the present disclosure;

FIG. 10 is a Filter Cartridge Bottom CPVC Plate, consistent with various aspects of the present disclosure;

FIG. 11 is a Filter Cartridge Filtration Media, consistent with various aspects of the present disclosure;

FIG. 12 shows the high voltage feed standoff, consistent with various aspects of the present disclosure;

FIGS. 13A-13B show the high voltage feed tube pin, consistent with various aspects of the present disclosure;

FIG. 14 is a Negative Electrostatic Filtration Apparatus Controller Circuitry, consistent with various aspects of the present disclosure;

FIG. 15 shows a top-down view of an electrostatic filtration apparatus according to an embodiment of the present disclosure;

FIG. 16 shows a partial cutaway view of a filtration assembly according to an embodiment of the present disclosure; and

FIG. 17 shows a cross-sectional view of a filtration assembly according to an embodiment of the present disclosure;

FIG. 18 shows multiple views of a filtration assembly according to an embodiment of the present disclosure;

FIG. 19 shows a cross-sectional view of a filtration assembly according to an embodiment of the present disclosure;

FIG. 20 shows a top-down view of an electrostatic filtration apparatus according to an embodiment of the present disclosure;

FIG. 21 shows a top-down view of an electrostatic filtration apparatus according to an embodiment of the present disclosure;

While various embodiments discussed herein are amenable to modifications and alternative forms, aspects thereof have been shown by way of example in the drawings and will be described in detail. It should be understood, however, that the intention is not to limit the disclosure to the particular embodiments described. On the contrary, the intention is to cover all modifications, equivalents, and alternatives falling within the scope of the disclosure including aspects defined in the claims. In addition, the term “example” as used throughout this application is only by way of illustration, and not limitation.

### DETAILED DESCRIPTION

Aspects of the present disclosure are believed to be applicable to a variety of different types of apparatuses, systems, and methods for filtration of fluid contamination within a liquid. Specific embodiments, including electrostatic fluid filtration systems, are believed to be particularly beneficial to the removal of sub-micron contaminants The formation of sub-micron contaminants (e.g., varnish and sludge) in non-conductive fluids (e.g. dielectric fluids) will cause damage, over time, to machinery utilizing such fluids. While the present disclosure is not necessarily so limited, various aspects of the disclosure may be appreciated through a discussion of examples using this context.

Fluid contamination in hydraulic and lubrication systems will cause excessive wear, and/or machinery/system failure over time. Common contamination in industrial systems includes varnish contamination, which is at least in part a by-product of oil-degradation in these systems. The occurrence of oil-degradation, and the resultant varnish deposition, has been associated with tighter filtration requirements, higher flow rates for lubricating oil, increased machinery operating temperatures, and industry migration to Group II based oil formulations. By utilizing electrostatic fluid filtration systems disclosed herein, varnish, sludge, and other deposit formations will be filtered from the fluids utilized in industrial machinery systems, thereby maintaining system reliability, and production continuity in a manufacturing or production environment. Various industrial systems particularly susceptible to damage associated with contaminant build-up in hydraulic and lubrication fluids include bearings and servos.

Mechanical components in industrial machinery are particularly susceptible to contaminant deposition on metal surfaces, such as reservoirs, bearings, and servo-valves. These deposits are often thin, insoluble films. Many contaminants associated with oil-degradation, such as varnish, have high molecular weights and are insoluble in oil. It has been discovered that contaminants, such as varnish insoluble are more than 75 percent soft contaminants that are less than 1 micron in size and are not detected by traditional laboratory analysis. Due to the contaminants sub-micron size, traditional mechanical filters (effective to ^{˜}3 micron) due not remove the contaminants from hydraulic and lubrication fluids as well as mineral oil cooling mediums. Without filtration from the fluid, the polar affinities of the sub-micron insoluble compounds, over time, draws the contaminants to proximal machine surfaces and are eventually deposited thereon. Upon deposition, deposited surfaces may exhibit a gold or tan color, gradually deepening over time to darker gum-like layers that eventually develops into varnish. In hydraulic applications, for example, the varnish will alter the frictional characteristics of the machine surface causing increased wear to adjacent contacting components. In lubrication applications, for example, the altered machine surface will cause increased turbulence to the flow of lubricant decreasing efficiency and/or increasing operating temperature.

The build-up of sub-micron insoluble contamination particles in industrial machinery will also create lubricant imbalances. Lubricant imbalances, over time, will further accelerate oil-degradation and additional contaminant propagation. Such lubricant imbalances contribute to a number of factors including oxidation, cross- and chemical-contamination, micro-dieseling and adiabatic compression. The difficulty of reducing and/or eliminating such factors all together in any lubricant or hydraulic application would be exceedingly difficult and likely cost prohibitive. Embodiments of the present disclosure reduce the need to address such lubricant imbalances in a given application by removing the harmful by-product contaminants from the system prior to depositing to machine surfaces in the system and resulting wear and damage.

Contaminant deposits on machine surfaces can cause numerous operational issues by interfering with the reliable performance of the fluid and the machine's mechanical movements. They can also contribute to wear and corrosion or simply just cling to surfaces. In one specific example, contaminant build-up will prevent hydrodynamic lubrication of a bearing surface, resulting in bearing failure. In yet other applications, contamination in hydraulic applications will cause restriction and stiction in moving mechanical parts such as servo or directional valves, and/or increased component wear due to varnish's propensity to attract dirt and solid particle contaminants. In heat exchanger applications, contamination will reduce heat transfer due to varnish's insulation effect. In various applications, catalytic deterioration of the lubricant will reduce the affective life of the lubricant increasing operating costs. Contaminants has also been discovered to plug small oil flow orifices and oil strainers, increase friction, heat and energy, damage mechanical seals, cause bearing failure, etc.

Various embodiments of the present disclosure are directed to an apparatus comprising: a conductive housing, a plurality of positive electrodes and a plurality of negative electrodes alternately disposed between the positive electrodes, within the conductive housing. Each alternately disposed set of positive and negative electrodes form an electrostatic field between each of the positive and negative electrodes in response to the negative electrodes receiving a negative voltage. The electrostatic field acts on contaminants within a fluid flow extending between the positive and negative electrodes to filter the contaminants from the fluid. A removable filter cartridge including a filter media extending between each of the positive and negative electrodes within the conductive housing removes additional contaminants from a fluid flow extending between the positive and negative electrodes. A negative power supply, electrically coupled to the negative electrodes; transmit the negative voltage to the negative electrodes. Similarly, the conductive housing and the positive electrodes are electrically coupled to one another to form an electrical ground. In more specific embodiments, the plurality of positive and negative electrodes are flat and maintain a specified spacing as to result the strongest and most consistent electrostatic field (spacing subject to scale). Alternatively, the negative emitter probe is similarly spaced from the collector tube created an enhanced electrostatic filed or corona applicable to smaller reservoirs of dialectic fluids.

In certain specific embodiments, a plurality of positive and negative electrodes and a conductive housing direct the flow of fluid within the conductive housing axially in response to a first electrostatic field between a first pair of positive and negative electrodes with a first electrical charge, and to flow radially inwards away from an outer wall of the conductive housing in response to a second electrostatic field between the next set of positive and negative electrodes with an electrical field different then the first electrostatic field.

In many embodiments, a plurality of positive electrodes has a circumference greater than a circumference of each of a plurality of negative electrodes. In such embodiments, each of the plurality of positive electrodes will be electrically and mechanically coupled to the conductive housing. In yet other embodiments, each of the plurality of negative electrodes will be electrically coupled to one another by conductive off-sets, and each of the plurality of positive electrodes are electrically coupled to one another by conductive off-sets.

In specific embodiments of an electrostatic fluid filtration apparatus, consistent with various aspects of the present disclosure, a conductive housing of the apparatus further includes a fluid inlet positioned at a distal end of the conductive housing. The fluid inlet receives a flow of contaminated fluid into the conductive housing, and a fluid outlet positioned at a proximal end of the conductive housing to output a flow of de-contaminated fluid from the conductive housing. In various embodiments, the conductive housing may take a number of shapes including a cylinder, a cube, etc.

Various example embodiments are directed to a system for removing insoluble contaminants from a nonconductive fluid. The system comprising an electrostatic fluid filtration device, a power supply, a fluid flow pump, a contaminant sensor, and controller circuitry and software. Some embodiments may utilize the internal pump of the machine or turbine, that is designed to circulate the dialectic fluid to and from the reservoir, thereby eliminating the need for an auxiliary pump and lowering the associated cost therewith. The electrostatic fluid filtration device includes a conductive housing, a plurality of positive electrodes, a plurality of negative electrodes, and a removable filter cartridge, or a single emitter probe and a single collector tube. The plurality of negative electrodes is alternately disposed between the positive electrodes within the conductive housing. Each alternately disposed pair of positive and negative electrodes form an electrostatic field between each of the positive and negative electrodes in response to the negative electrodes receiving a negative voltage. The electrostatic field acts on contaminants within a fluid flow extending between the positive and negative electrodes to filter the contaminants from the fluid. The conductive housing and the positive electrodes are electrically coupled to one another to form an electrical ground. The removable filter cartridge includes a filter media extending between each of the positive and negative electrodes within the conductive housing. The filter media removes additional contaminants from a fluid flow extending between the positive and negative electrodes. The plurality of positive and negative electrodes and the conductive housing direct the flow of fluid within the conductive housing axially in response to a first electrostatic field between a first set positive and negative electrodes with the electrical charge. The plurality of positive and negative electrodes and the conductive housing further direct the flow radially outwards towards the outer wall of the conductive housing in response to the next electrostatic field between the next set of positive and negative electrodes with an electrical field separate then the first electrostatic field. The negative power supply electrically coupled to the plurality of negative electrodes and negative electrodes electrically coupled together and to the conductive housing to produce a ground produce a series of alternating electrical fields between each set of electrode plates. Alternatively, the negative power supply is connected to the singular emitter probe which is surrounded by the singular positive collector tube. The fluid flow pump coupled to an inlet of the conductive housing directs a flow of fluid into the electrostatic fluid filtration device. The contaminant sensor, coupled to the inlet and/or an outlet of the conductive housing, detects the contaminant level of the fluid flowing past the contaminant sensor. The controller circuitry and software receives data from the fluid flow sensor indicative of a fluid flow rate, data from the contaminant sensor indicative of fluid contaminant level, data from the pressure and vacuum transducers, data from the water sensor, and data indicative of an output of the power supply. This data is reported and analyzed to determine filter life.

In more specific embodiments of the system for removing insoluble contaminants from a nonconductive fluid, the controller circuitry and software further includes communication circuitry to transmit data received by the controller circuitry and software to remote computer circuitry software. The aggregated data produced from the apparatus could be collected and transmitted wirelessly or wired to another device for storage or further analysis remotely.

Detailed embodiments of the system for removing insoluble contaminants from a nonconductive fluid may further include a water sensor, coupled to an inlet or outlet of the electrostatic fluid filtration device that transmits data to controller circuitry and software indicative of the existence of water within the fluid flow entering the electrostatic fluid filtration device. The controller circuitry and software, in response to receiving data from the water sensor indicative of the existence of water within the fluid flow, shuts down the fluid flow pump, and output of the power supply, and indicates to an operator the need to stop the operation of the electrostatic fluid filtration device.

Controller circuitry and software of the present disclosure may analyze data received from the fluid flow sensor, indicative of a fluid flow rate, data from the contaminant sensor indicative of fluid contaminant level, data from the pressure and vacuum transducers, data from the water sensor, and data indicative of an output of the power supply, and based on the analyzed data characterize the fluid filter within the electrostatic fluid filtration device. Optionally, the controller circuitry and software may indicate to an operator that a filter change is necessary once the contamination of the filter exceeds a threshold level.

Various embodiments of the system for removing insoluble contaminants from a nonconductive fluid including an electrostatic fluid filtration device that eliminates varnish within machine surfaces in contact with the fluid by reducing the contaminant level within the fluid below a contaminant saturation level; wherein, contaminants comprising the varnish are drawn from within the machine surfaces into the fluid whereby the contaminants are filtered by the electrostatic fluid filtration device. Optionally, the system may include a reservoir that holds the fluid. The reservoir may be coupled to the rest of the system in a number of configurations, including for example, it may be coupled to an inlet and outlet of the electrostatic fluid filtration device in a kidney loop configuration or installed “In Line” utilizing the traditional flow of dialectic fluid within the subject device.

In various specific/experimental embodiments of the present disclosure, an electrostatic fluid filtration system removes sub-micron insoluble contaminants known to cause both varnish and sludge from non-conductive fluids such as dielectric fluids. The electrostatic fluid filtration system removes contaminants from a target fluid (e.g. a dielectric fluid) by directing the targeted fluid through a stack of electrostatic filtration electrodes. The number of electrostatic filtration apparatus' in series or parallel may vary based on the particular application, the contamination level of the fluid, and the desired filtering time to a desired purity. The electrostatic filtration apparatus applies an electrostatic charge to the fluid flowing through the cartridges. The electrostatic charge has no effect on dielectric fluids flowing through the electrostatic filtration apparatus. However, conductive materials such as contaminants have a force induced upon them by the electrostatic charge, which allows for the filter and capture of such contaminants.

To increase the efficiency of the electrostatic fluid filtration system, control circuitry and software will maintain voltage from the power supply inputs thereto. The system may further utilize a number of sensors to determine the condition of the filter before and after filtration to determine the efficacy and to analyze the filtering properties of the system. Inline water sensors may be utilized adjacent to the input and output of the system to determine water contamination levels of the fluid. Similarly, inline particle counters can be utilized to determine sub-micron contaminants in the fluid before and/or after filtration. It is to be understood that a myriad of sensors may be utilized to further improve the efficiency and efficacy of the electrostatic fluid filtration system, and such systems are readily encompassed by the present disclosure. Further examples of sensors that various embodiments of the present disclosure may utilize include, but not necessarily limited to: an oil temperature sensor, a flow switch, a float switch, a digital pressure gauge, a digital vacuum gauge, etc.

In application specific embodiments, one or more conductive filtration units could be utilized in series or in parallel (depending on application contamination levels). In many contaminant-intensive applications, the electrostatic fluid filtration system may include a number of electrostatic filtration apparatus' in parallel with filters that may be replaced periodically when filtration efficiency of the system degrades. In more specific embodiments, the control circuitry and software may be communicatively coupled via wired/wireless communication to other computer circuitry allowing for remote, real-time updates of electrostatic fluid filtration system status. These updates may include information on the filtration system including contamination levels, etc. based on the received sensor data.

Embodiments of the electrostatic fluid filtration system could further include electronic data storage communicatively coupled to the controller circuitry and software. During filter operation, the controller circuitry and software will analyze various data on the fluid received from the sensor(s) communicating with the controller circuitry. This data analyzed by the electrostatic fluid filtration system to determine when filter cartridges have reached the end of their useful life. In yet further more specific embodiments, the controller circuitry and software can utilize sensor data to optimize fluid filtration by analysis, and even extend the life of the machine utilizing the filtered fluids notification of required filter change. For example, where the electrostatic fluid filtration system determines that the filter within the apparatus meet a threshold, the apparatus filtering the fluid notifies user of filter life and/or replacement required or apparatus shut-down to prevent damage.

In more basic embodiments of the present disclosure, an electrostatic fluid filtration system may only have a single filter cartridge housing. During operation of the electrostatic fluid filtration system, with an electrostatic filter cartridge installed in the conductive housing, the target fluid will be electrostatically filtered. When the controller circuitry and software receives data from a water sensor in the system indicative of the presence of water levels above a desired threshold level, the controller circuitry will initiate a water contamination state. In the water contamination state, the controller circuitry may: shut-down the machine utilizing the water contaminated fluid to prevent damage, alert an operator of the state. After the water sensor data indicates that the water levels are back within a desired threshold, normal operation may resume.

Many embodiments of the electrostatic fluid filtration system may include the use of controller circuitry and software to monitor contaminant particle counts (via inline particle counter or other similar sensor) in the filtered fluid for filter efficacy analysis. This data may be monitored by an operator at the controller circuitry, or remotely (where the controller circuitry is communicatively coupled via wired/wireless communications to other computer circuitry). In such embodiments, all functions of the electrostatic fluid filtration system may be monitored by the controller circuitry, including: water and particle contamination), pressure (vacuum), filter life, leak detection, fluid flow, filter current levels, filter high voltage levels, oil temperature, system total run hours, among others.

The electrostatic fluid filtration system may include a sealable conductive housing with a replaceable cartridge comprising a number of spaced parallel electrode plates and sections of a filtration media placed between the electrode plates, alternatively, it may have a single probe emitter surrounded by a single tube collector configuration. In the filtration unit, the target fluid flows axially and radially through the filtration media that is positioned between the electrode plates in a generally horizontal flow pattern. This forces the targeted fluid to traverse alternating multiple electrostatic fields in a linear fashion and in a single pass through the contaminant filtration unit. The electrostatic fields created by the alternating electrode plates, or Probe/Collector configuration, act on conductive contaminants to filter and/or trap such contaminants in the filtration unit, while allowing the dielectric fluid to freely traverse through the electrostatic fluid filtration system. Proper treatment of contaminated fluid may be accomplished by controlling the amount of time the fluid remains in the filtration unit, the number of passes through the unit, as well as increasing the filter surface area that the target fluid is exposed to during treatment.

In another specific/experimental embodiment, an electrostatic fluid filtration system for removing molecularly insoluble contaminants known to cause both varnish and sludge from fluids such as dielectric fluids are disclosed. The electrostatic fluid filtration system including a housing that houses: control circuitry, one or more pumps, one or more high voltage power supplies, an inline water sensor, an inline particle counter, a flow switch, a float switch, an oil temperature sensor, wired/wireless communication circuitry for remote monitoring and system diagnostics of the system, a digital pressure/vacuum gauge, and an electrostatic filtration unit. The filtration unit comprises a conductive housing, replaceable filter cartridge positioned within the housing, and a removable lid to facilitate replacement of the replaceable cartridge. It is further to be understood that in very other embodiments that the electrostatic fluid filtration system need not be contained within a single housing and in some larger filtering applications a single housing for all of the above mentioned components may not be feasible.

In many embodiments, the electrostatic filtration unit includes a conductive housing with inlet and outlet ports being located opposite from one another on the housing. A replaceable cartridge including a number of electrode plates that are positioned inside the electrically conductive housing, alternatively, it may have a single probe emitter surrounded by a single tube collector configuration. Each of the adjacent electrode plates are oppositely electrically charged (negative or positive). A filtration media is placed between each oppositely charged electrode plate pairing, or a Probe/Collector configuration. For treatment, a fluid is pumped at a relatively low pressure into the filtration unit at the inlet port. The pressure of the fluid to be treated is greater than a head pressure of a machine the electrostatic fluid filtration system is connected thereto.

Various embodiments of the present disclosure improve conductivity between the electrically conductive housing and the replaceable filter cartridges utilizing a twist lock connection that ensures absolute mechanical contact there between. This electrically conductive connection is critical to the efficiency of the filter unit as the negative electrode plates, or probe, are electrically charged. The positive electrode plates, or collector tube, are connected through a section of the conductive housing wall. The twist lock connection allows for easy removal of filter cartridges from the conductive housing where required for maintenance or replacement, while also providing increased conductivity between the conductive housing and the electrode plates reducing power losses and increasing contaminant capture rates during filter unit operation.

In specific embodiments requiring increased contaminant capture rates while maintaining smaller space requirements, scaling of the apparatus may be desirable, to include increase or decrease in the number and configuration of electrodes, size of apparatus, pumps, plumbing, housings, etc. The scalability may increase the efficiency of the electrostatic filtration apparatus. Depending upon the reservoir size, increasing or decreasing the number of electrostatic fields, and/or time of filtration, required to clean the target fluid to a desired level may be adjusted.

In many embodiments of the present disclosure, during operation, an electrostatic fluid filtration system receives fluid to be treated through an inlet zone located at the bottom of the conductive housing. During filtration, the fluid flows axially (relative to the circular conductive housing), until it contacts an electrode plate which forces the fluid to flow radially through a filtration media that is positioned between the electrode plates, or probe and collector as the case may be, until it reaches the wall of the conductive housing where the fluid momentarily flows axially until again being re-directed through another filtration media between two electrode plates. Depending on the electrostatic fluid filtration system, this flow of the fluid is repeated until the fluid has passed between each successive pairs of electrode plates, or probe and collector, and through all of the filtration media, after which the de-contaminated fluid exits the conductive housing via an outlet port.

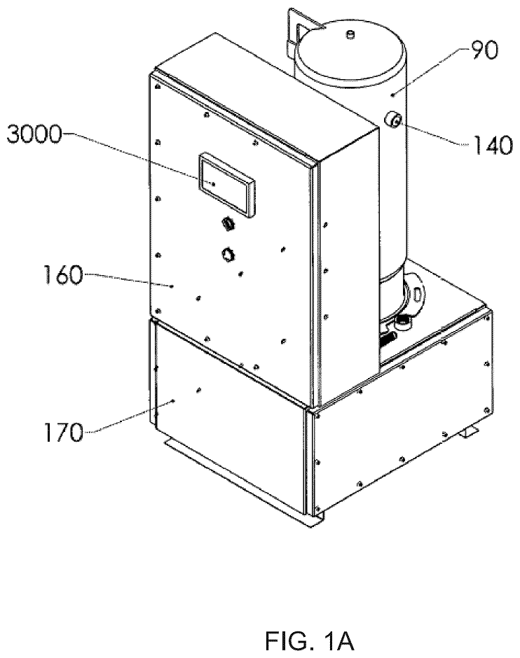

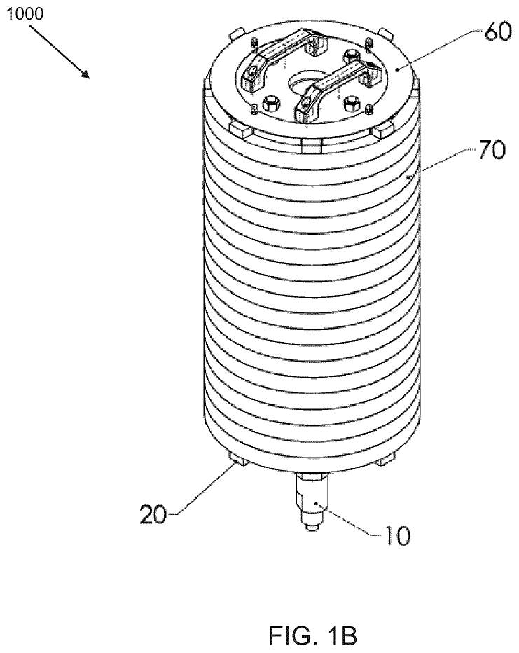

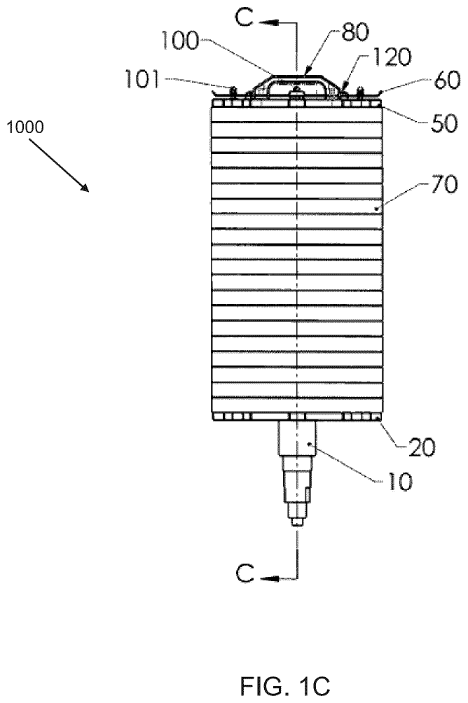

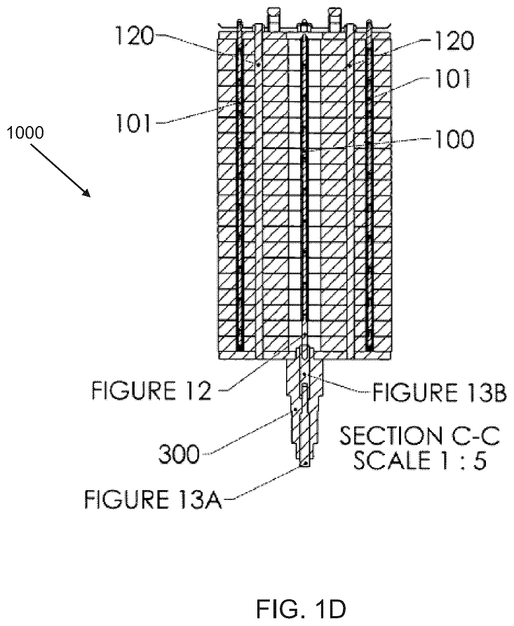

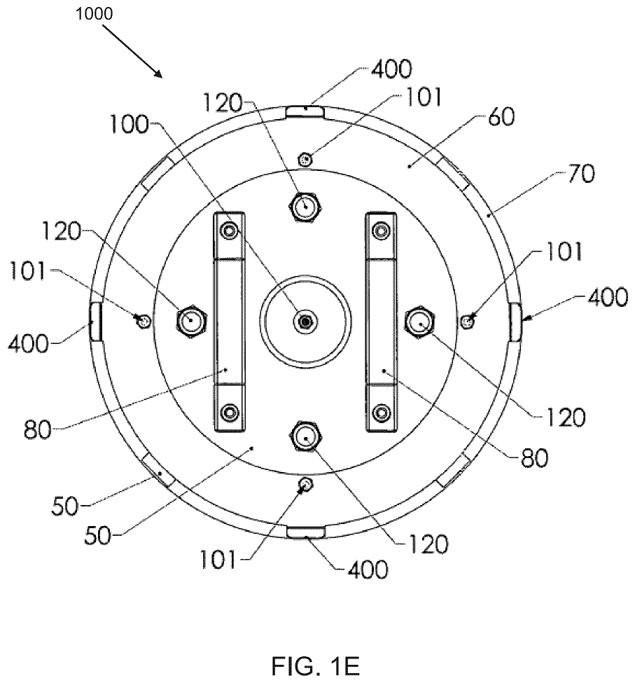

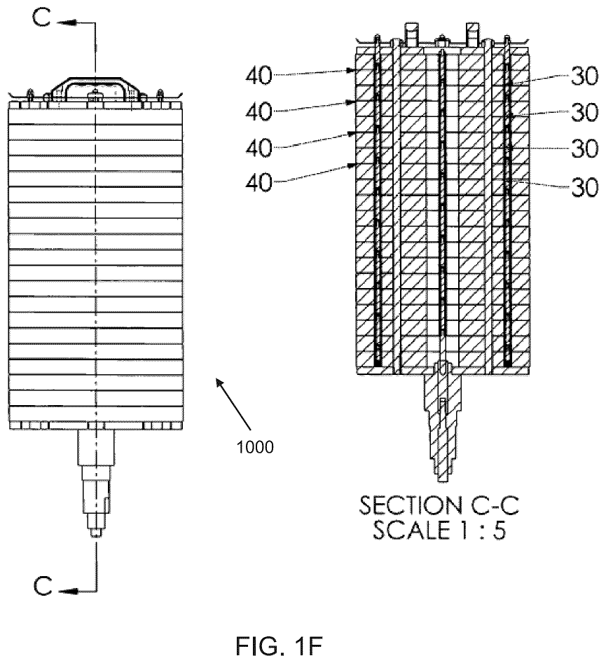

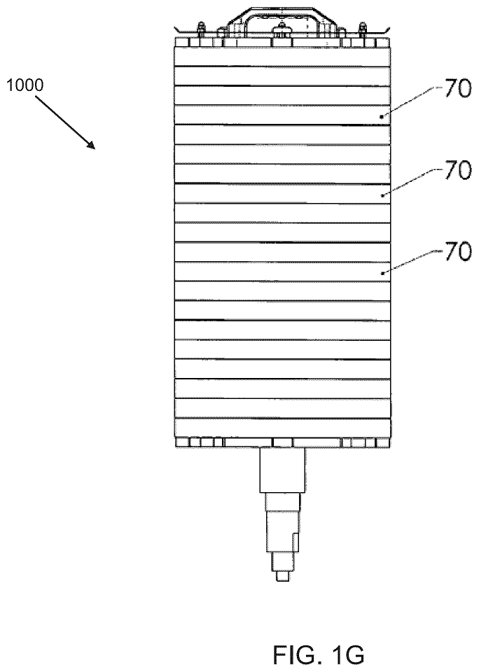

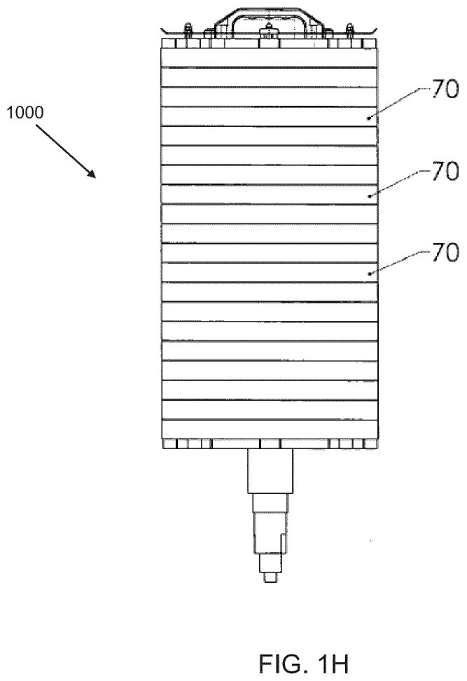

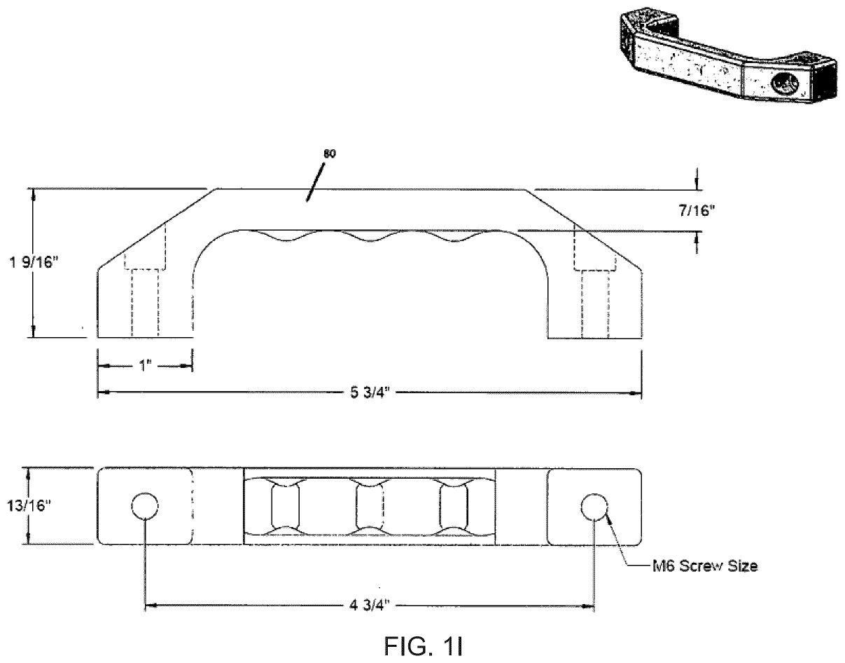

Turning now to the figures, various embodiments of the present disclosure are presented by way of the illustrations. FIGS. 1A-1I are isometric views of an electrostatic filter cartridge 1000 of an electrostatic fluid filtration system, with and without electrostatic filter media 70 (also referred to as filter media) installed, respectively. The insulated high voltage module 10 delivers high voltage from a power supply to the conductive housing. The bottom filter plate 20 mounts the filter media 70 (which may be either conventional or non-conventional filter media; e.g., cellulose, reticulated foam, glass fiber, paper) to the insulated high voltage module 10, which in some embodiments utilizes a twist lock connection allowing for more efficient electrical conduction between the high voltage module 10 and negative electrodes 30 and positive electrodes 40 of the filtration system. A top filter plate 50 is located at the top of the electrostatic cartridge apparatus, with the bottom and top filter plates, 20 and 50 respectively, sandwiching the filter media 70 and positive and negative electrodes (40 and 30). A top ground plate 60 coupled to the top of the electrostatic filter cartridge 1000 prevents electrical discharge of the high voltage flowing between the positive and negative electrodes from extending outside of the conductive housing. For ease of access of the electrostatic filter cartridge within the conductive housing for maintenance and replacement of filters, handles 80 are coupled to the top ground plate 60. In embodiments utilizing a twist lock connection. A simple rotation of the handle will release the electrostatic filter cartridge from the conductive housing and allow for access to the filters 70 within.

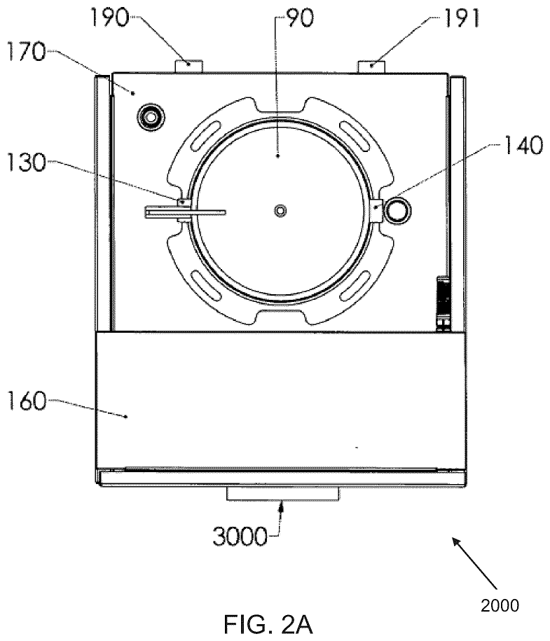

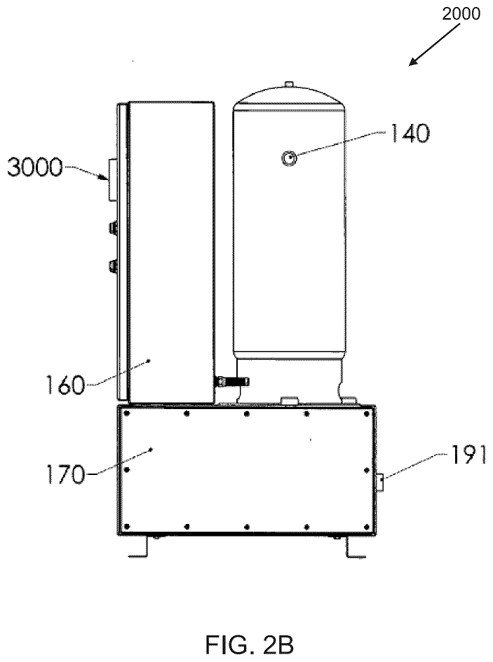

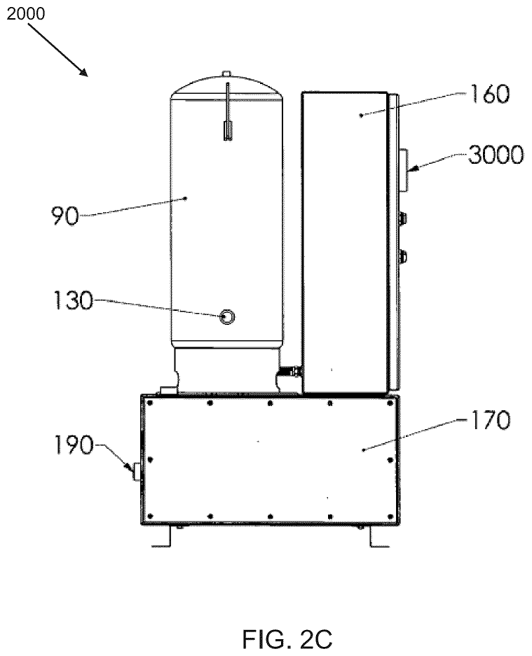

FIG. 2A is a top view of an electrostatic fluid filtration system 2000, consistent with various aspects of the present disclosure. An electrostatic filter cartridge 1000 is inserted within a conductive filter housing 90, with handles 80 and top ground plate 60 viewable. An access hole through the top ground plate 60 provides a fluid flow path from the exit of fluid from the electrostatic fluid filtration system 2000.

FIGS. 2B-2C are cross-sectional side views of the electrostatic fluid filtration system 2000 of FIG. 2A, consistent with various aspects of the present disclosure. An insulated high voltage module 10 coupled to bottom filter plate 20 provides a negative electrical connection to a high voltage power supply. A negative electrode 30 is interconnected to the alternating negative electrodes 30 via filter negative insulated pole connectors 100 and finally connected to top ground plate 60 and the conductive filter housing 90. Positive electrodes 40 are interconnected to one another via insulated pole connectors 101. Insulated filter support rods 120 hold the electrostatic filter cartridge 1000 rigidly together. The top ground plate 60 and a top filter plate 50 are coupled to one another with an offset. The grounding of both the top ground plate 60 and the conductive filter housing 90 prevent electrical discharge outside of the electrostatic fluid filtration system 2000.

In operation, a target fluid enters the conductive filter housing 90 at fluid inlet 130. The fluid gradually fills (at low pressure) the conductive filter housing 90 until it exits the housing via the fluid outlet 140. The target fluid flows both radially and axially throughout the conductive filter housing 90 traversing through the filter media and between the alternating positive and negative electrodes, 40 and 30. Once the conductive filter housing 90 has been pressurized by fluid, a high voltage power supply is energized and transmits power to the negative electrodes creating electrostatic fields between the positive and negative electrodes. The electrostatic fluid filtration system 2000 removes electrically conductive contamination from the fluid at the molecular level by inducing a force that separates the contamination from the fluid, which is then bonded to the positive and negative electrodes, 40 and 30. In addition, some nonconductive contaminants may be captured in the filter media between each pair of electrodes. In many embodiments, the electrostatic fluid filtration system 2000 is monitored by controller circuitry. Relevant system data may be uploaded via wired/wireless communication to remote storage and/or controller circuitry 3000.

High voltage electricity is applied to the electrostatic fluid filtration system 2000 via the insulated high voltage module 10. Filter media may be mounted to the insulated high voltage module item 10 via a twist lock connection for a negative electrical connection. The remainder of the electrostatic filter cartridge 1000 is grounded to the conductive filter housing 90 via top ground plate 60 completing the electrical circuit.

The close fitting tolerance of the positive electrode 40 to the conductive filter housing 90 forces the target fluid to flow inwards to the center of the filter assembly and then outwards to the conductive filter housing wall. The top filter plate 50 and the bottom filter plate 20 hold the filter ends rigidly together utilizing the filter support rods 120. The filter negative pole 100 is used to connect the negative electrodes to each other. The filter positive poles 101 are used to connect the positive electrodes to each other and are insulated so as not to short out to the negative electrodes. The filter media can be composed of various materials both conventional and non, these are also connected to the ground plate 60 to complete the circuit. The thickness of the filter media 70 is set to specific distance for optimized electrostatic field.

During cleaning, the electrostatic fluid filtration system 2000 may be monitored by controller circuitry 3000, which controls the pump for the fluid through the filtration system and the characteristics of the electrostatic field created between the electrodes. In various embodiments, the controller circuitry 3000 may also monitor pressure/vacuum of the system, water content of the target fluid, detect leaks, particle count (contamination), filter life, power supply output voltage and current, target fluid temperature, and fluid flow rate through the system. As discussed in more detail above, such sensory data may be utilized by the controller circuitry 3000 to display run characteristics of the system locally as well as remote in some applications, filter efficacy, and the contaminant removal rate.

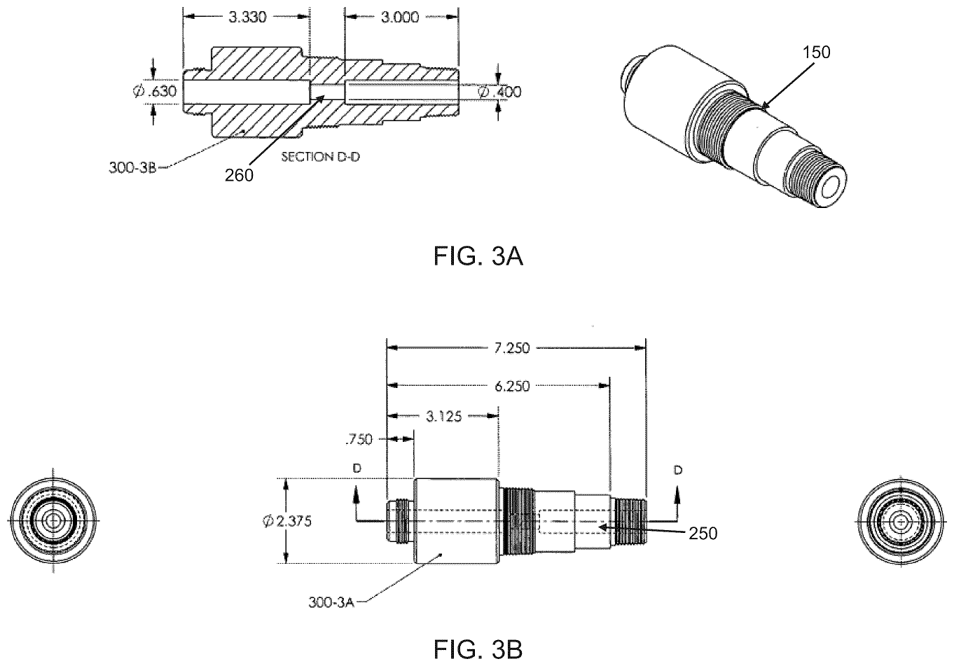

FIG. 3A is a side view of an insulated high voltage module 10, consistent with various aspects of the present disclosure. The insulated high voltage module 10 including a twist lock connection 150 for easy coupling to the remainder of the electrostatic filter cartridge 1000.

FIG. 3B is a cross-sectional side view of the insulated high voltage module 10 of FIG. 3A, consistent with various aspects of the present disclosure. To operate the electrostatic field between the electrodes in the system, a high voltage power line enters through opening 300, extends through passage 250, which includes a gasket 260 that prevents the escape of fluid within the system through opening 300. The high voltage power line then extends through opening 300 and is electrically coupled to the negative electrodes within the system.

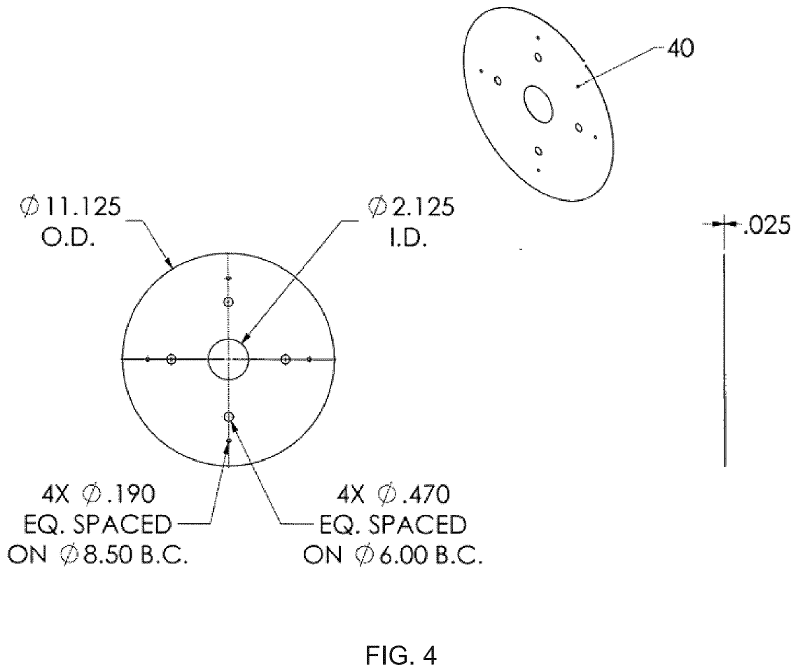

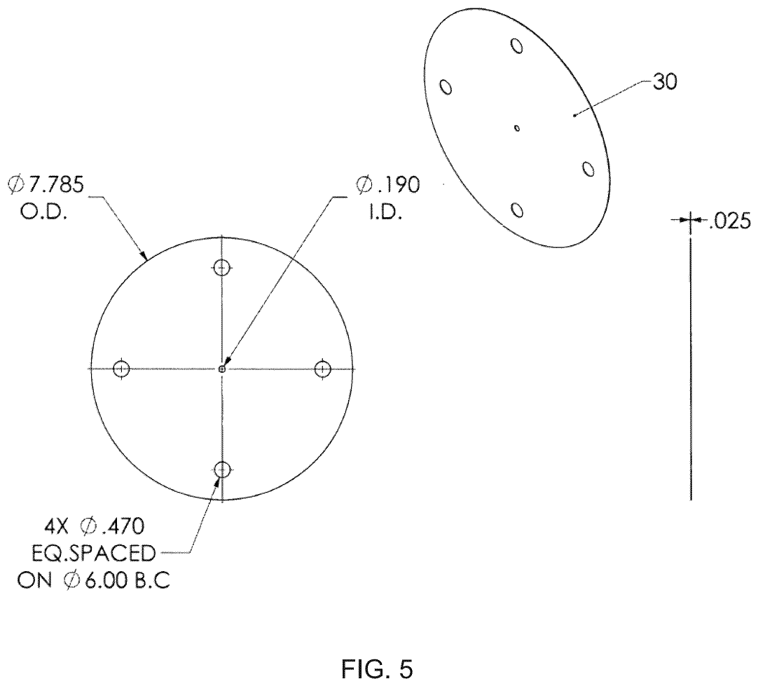

FIG. 4 is a top view of a positive electrode 40 of an electrostatic filter cartridge, consistent with various aspects of the present disclosure. FIG. 5 is a top view of a negative electrode 30 of an electrostatic filter cartridge apparatus, consistent with various aspects of the present disclosure. To increase the electrostatic field between the negative and positive electrodes in an electrostatic filtration system, the electrode plates are kept at a specific and consistent spacing. This greatly increasing the efficiency of the removal of fluid contaminants, especially sub-micron, insoluble, contaminants.

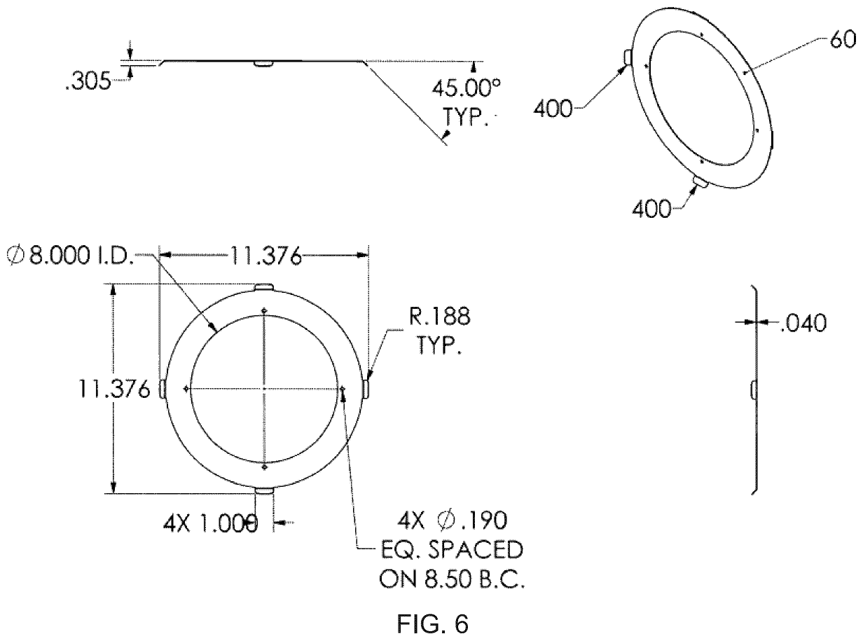

FIG. 6 is a top view of a top ground plate 60 of an electrostatic cartridge apparatus, consistent with various aspects of the present disclosure. When installed within a conductive filter housing, tabs 400 positively positions the filter cartridge assembly within the conductive filter housing, while electrically coupling the top ground plate 60 to the conductive filter housing via the tabs 400. These positive connection provide for greater power efficiency of the electrostatic filtration system.

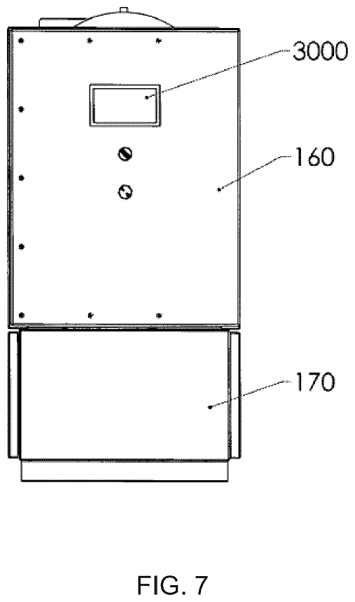

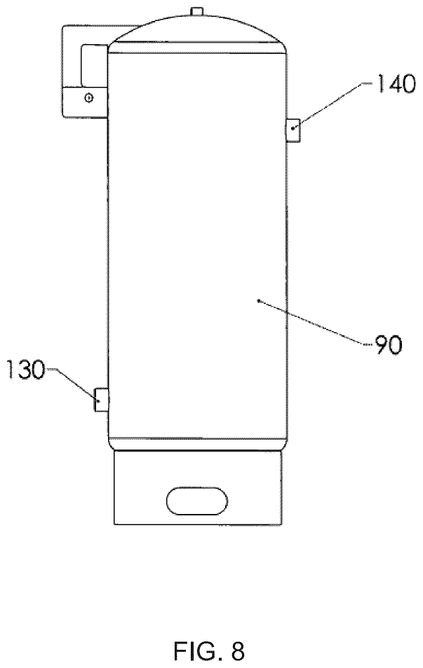

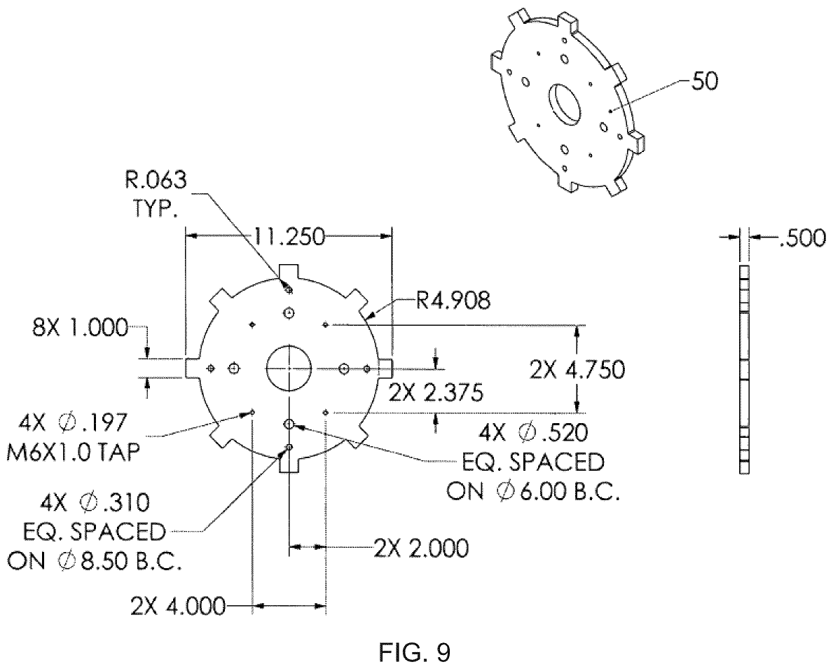

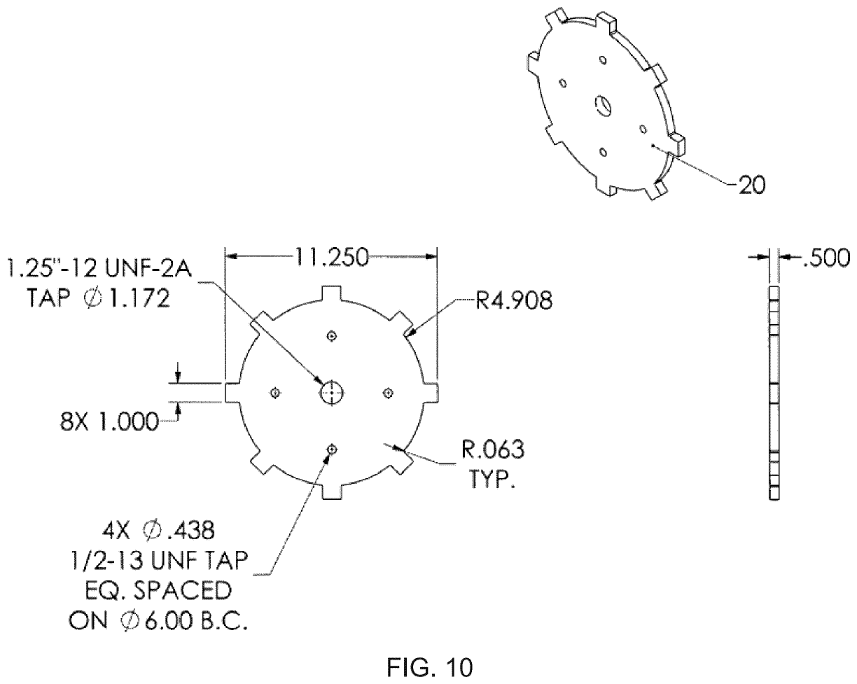

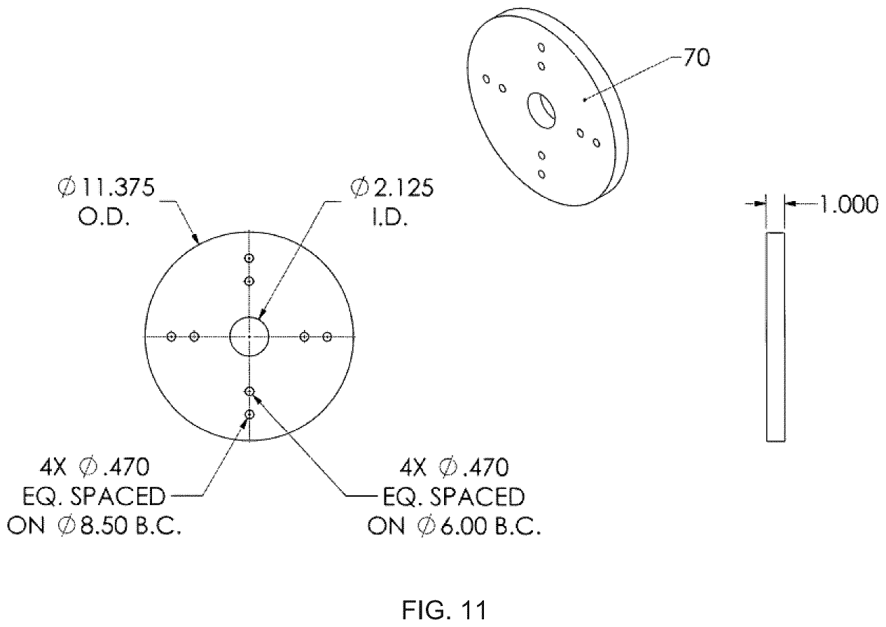

FIG. 7 is a front view of an electrostatic fluid filtration system 2000, consistent with various aspects of the present disclosure. A housing 160 contains the entirety of the liquid filtration system including: controller circuitry 3000, particle counter display, conductive filter housing 90, hydraulic pump cabinet 170. A fluid inlet 190 and fluid outlet 191 are located at the rear of the housing 160. During operation an operator may check the status of the electrostatic fluid filtration system 2000 via the controller circuitry 3000 and/or particle counter display.

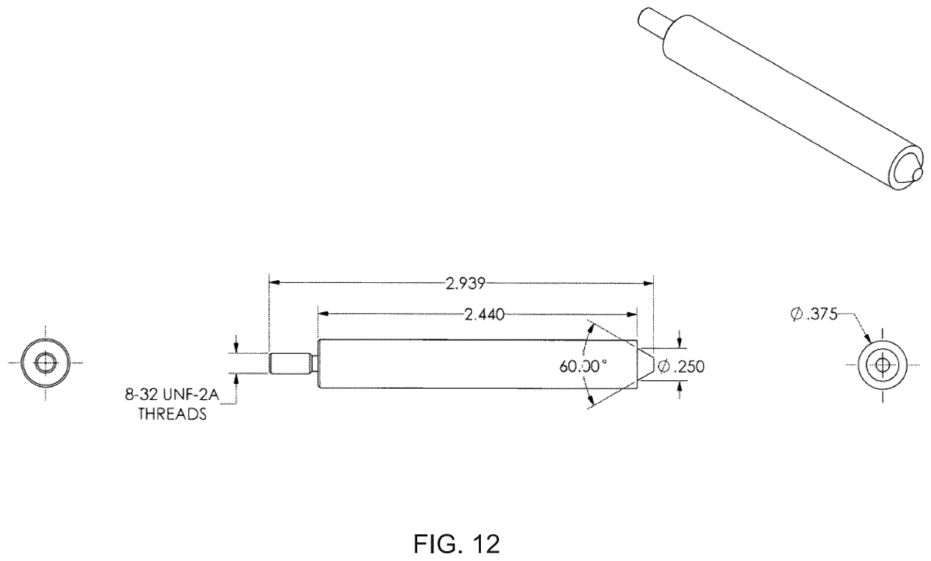

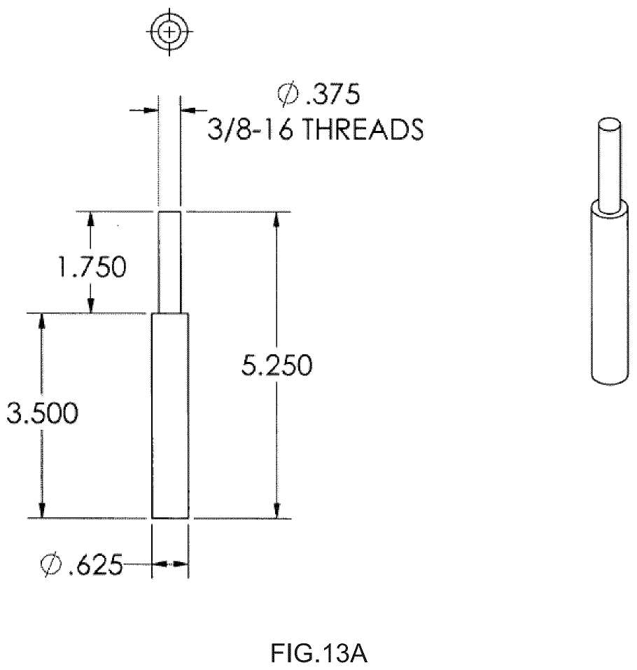

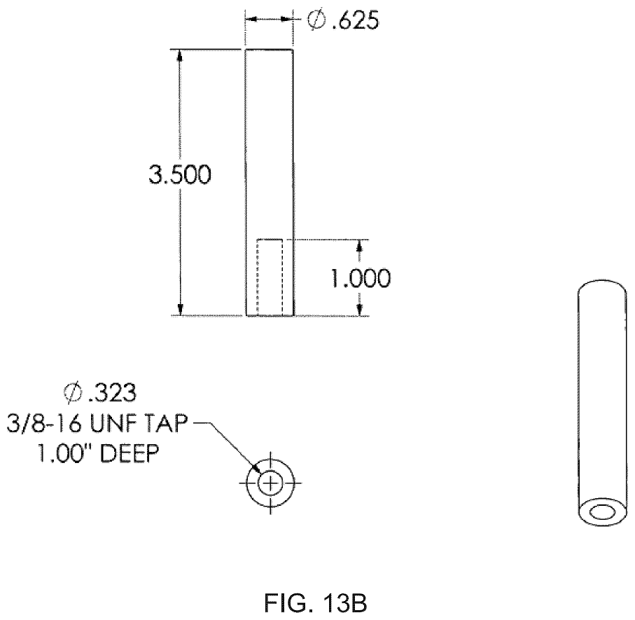

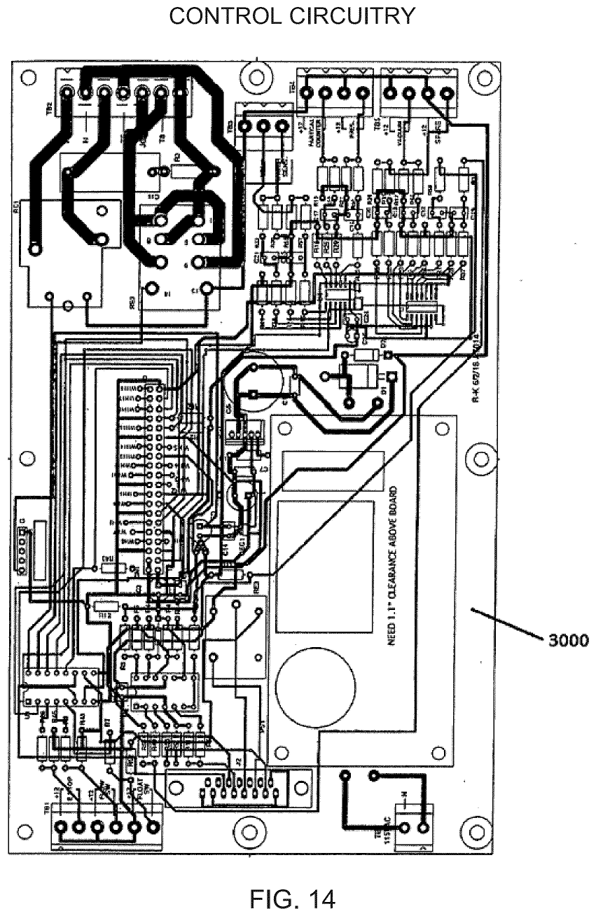

FIG. 12 shows the high voltage feed standoff that is connected to the negative electrodes and offsets at the bottom of the electrostatic filter cartridge, consistent with various aspects of the present disclosure. This piece provides a solid mechanical connection to the negative high voltage power source via FIGS. 13A-13B.

FIGS. 13A-13B show the high voltage feed tube pin, consistent with various aspects of the present disclosure. This is a two-piece assembly, which includes a multi-purpose o-ring. The high voltage feed tube pin connects the negative electrodes 30 via the filter negative insulated pole connectors 100, to the negative high voltage power supply in the housing 160.

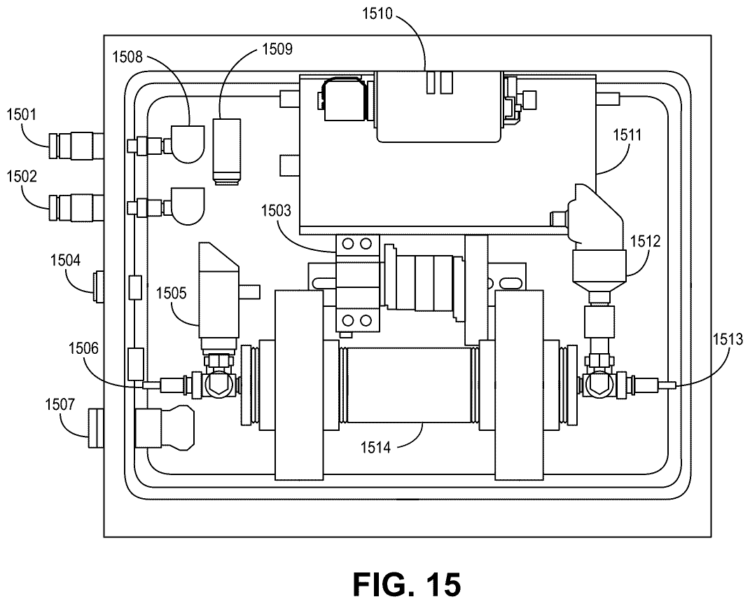

FIG. 15 is an example embodiment of the electrostatic filtration apparatus that includes a fluid inlet (1501), a fluid outlet (1502), an electronics assembly (1503), an electrical power inlet (1504), a pressure switch (1505), a collector connection (1506), an emergency stop switch (1507), at least one fluid control valve (1508), a fluid pump (1509), a particulate sensor (1510), a high voltage electrostatic generator (1511), a temperature switch (1512), and emitter connection (1513), and a filtration assembly (1514).

In the example embodiment, a dielectric liquid flow enters the electrostatic filtration apparatus through fluid inlet (1501), is pumped through the electrostatic filtration apparatus by fluid pump (1509), passes through filtration assembly (1514) where contaminants are filtered from the dielectric liquid flow, and exits the electrostatic filtration apparatus through fluid outlet (1502). Fluid inlet (1501) and fluid outlet (1502) may be fitted with fluid control valves (1508), such as solenoid valves, to provide a means of controlling when the dielectric liquid is allowed to flow through the electrostatic filtration apparatus. The example embodiment also includes an emergency stop switch (1507) which may be configured to close fluid control valves (1508) when the emergency stop switch is engaged.

Electrical power may be supplied to high voltage electrostatic generator (1511), electronics assembly (1503), and/or any other component of the electrostatic filtration apparatus via electrical power inlet (1504). High voltage electrostatic generator (1511) may be connected to filtration assembly (1514) via collector connection (1506) and emitter connection (1513). High voltage electrostatic generator (1511) provides the negative charges used to generate the electrostatic field within filtration assembly (1514). Electronics assembly (1503) controls fluid pump (1509) and/or the characteristics of the electrostatic field generated in filtration assembly (1514). The electronics assembly (1503) may also collect data from any sensors incorporated into the electrostatic filtration apparatus (e.g., pressure switch (1505), particulate sensor (1510), temperatures switch (1512), or any other sensor), and make that data available to the user via an integrated Modbus, or similar communication protocol. This data may be used, for example, to analyze system performance or predict unexpected wear issues in the external system (e.g., the turbine). In various embodiments, electronics assembly (1503) may monitor data provided by the pressure switch (1505), particulate sensor (1510), temperature switch (1512), or any other sensor, and adjust run characteristics to optimize performance of the electrostatic filtration apparatus.

Pressure switch (1505), which may include a vacuum sensor in some embodiments, provides a constant measure of pressure, and vacuum in some embodiments, within the electrostatic filtration apparatus. This data may be used as an indication that the fluid pump (1509) and/or filtration process are operating according to design. Temperature switch (1512) is a fail-safe sensor that may be configured to automatically shut down the electrostatic filtration apparatus if measured temperature exceeds an established threshold. Temperature switch (1512) may be of particular use in warmer climates where ambient temperatures may require the electrostatic filtration apparatus to shut down for the benefit of external systems or apparatuses. In such situations, it may be beneficial to shut down the electrostatic filtration apparatus to avoid generating additional heat even if the electrostatic filtration apparatus could continue to function effectively at such temperatures. Particulate sensor (1510) may be used to continuously monitor particle count and/or other measures of contamination of the target dielectric liquid. Readings from the particulate sensor (1510) may be made available to a user by integrated Modbus, or similar communication protocol, either directly by the particulate sensor (1510) or via the electronics assembly (1503). The information from the particulate sensor (1510) may be of particular use in analyzing system performance. For example, a large and sudden increase in particulate matter within the dielectric fluid may indicate a major issue has arisen in the external system (e.g., turbine) or even indicate imminent failure of the external system. Such information may warn a user of a need to shut down the external system to avoid costly or potentially dangerous system failure.

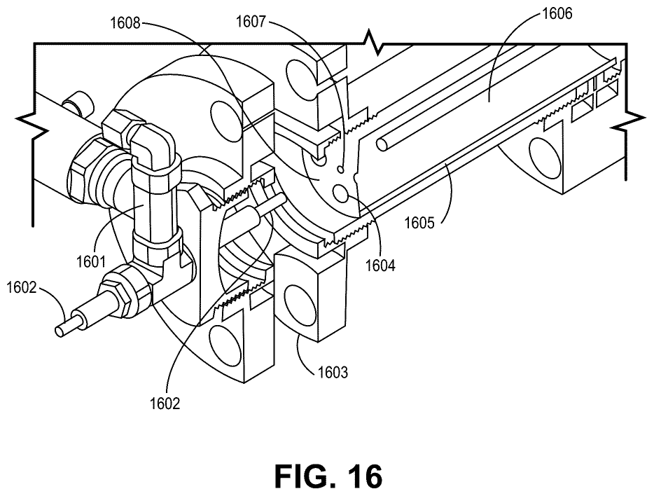

FIG. 16 shows a partial view of an example embodiment of filtration assembly (1514) in more detail. The embodiment includes filtration inlet (1601), collector connection (1602), non-conductive housing (1603), at least one fluid inlet hole (1604), positively charged collector cylinder (1605), negatively charged emitter probe (1606), threaded receptor hole (1607), and grounding plate (1608).

In an exemplary operation, a target dielectric liquid enters the filtration assembly (1514) in a continuous flow via the filtration inlet (1601). The dielectric liquid flows past grounding plate (208) and into positively charged collector cylinder (1605) via fluid inlet holes (1604). Within positively charged collector cylinder (1605), the large electric potential gradient between the positively charged collector cylinder (1605) and negatively charged emitter probe (1606) creates a strong electrostatic field. The electrostatic field negatively charges electrically conductive contaminant particles within the dielectric liquid flow, which are then attracted to positively charged collector cylinder (1605) with the assistance of the electrostatic field. Upon contact with positively charged collector cylinder (1605), the negatively charged contaminant particles may attach to positively charged collector cylinder (1605) whereby the contaminant particle is eliminated from the dielectric liquid flow. In this way, electrically conductive contaminants may be removed at the molecular level from a dielectric liquid flow.

Grounding plate (1608) is connected to collector connection (1602) by threaded receptor hole (1607). Note that FIG. 16 is a partially exploded view of filtration assembly (1514) and therefore does not show grounding plate (1608) as connected to the collector connection (1602). When the grounding plate (1608) is connected to collector connection (1602) and the flanges of non-conductive housing (1603) are bolted together, the spacing of collection connector (1602), grounding plate (1608), and positively charged collector cylinder (1605) is such that absolute mechanical contact between the three components is assured. In this way, grounding plate (1608) may provide an electrical ground via collector connection (1602).

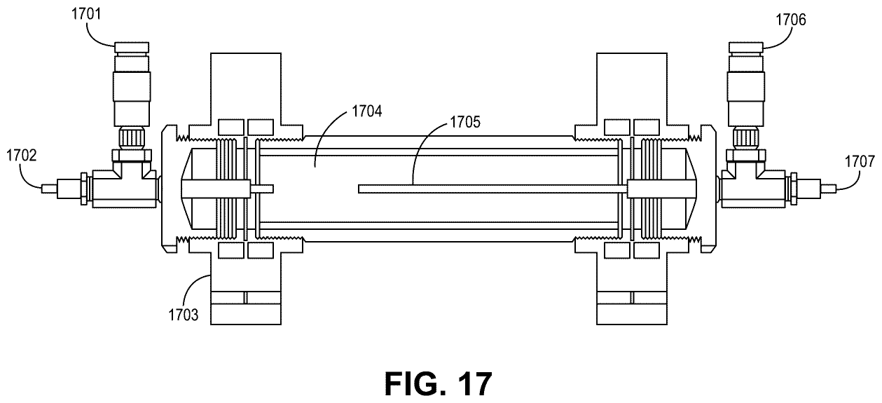

FIG. 17 is a cross-sectional view of an example embodiment of filtration assembly (1514). This example embodiment includes filtration inlet (1701), collector connection (1702), non-conductive housing (1703), positively charged collector cylinder (1704), negatively charged emitter probe (1705), filtration outlet (1706), and emitter connection (1707). Collector connection (1702) is connected to high voltage electrostatic generator (1511), allowing high voltage electrostatic generator (1511) to charge positively charged collector cylinder (1704) in the manner described above. Emitter connection (1707) is connected to high voltage electrostatic generator (1511) and negatively charged emitter probe (1705), allowing high voltage electrostatic generator (1511) to charge negatively charged emitter probe (1705).

In an exemplary operation, a target dielectric liquid enters the filtration assembly through filtration inlet (1701), and flows into positively charged collector cylinder (1704) where it passes through an electrostatic field generated by the large electric potential gradient between positively charged collector cylinder (1704) and negatively charged emitter probe (1705). The electrostatic field filters contaminants from the dielectric liquid in the manner described above. The target dielectric liquid exits the filtration assembly through filtration outlet (1706).

To create a strong electrostatic field within the positively charged collector cylinder (1605, 1704), and thereby ensure effective filtration of conductive contaminants, the radial distance between the interior surface of positively charged collector cylinders (1605, 1704) and the outer surface of negatively charged emitter probe (1606, 1705) can be maintained at about 0.5 inches to 1 inch. A more preferred distance between positively charged collector cylinders (1605, 1704) and the outer surface of negatively charged emitter probe (1606, 1705) is about 0.6 to 0.8 inches. The most preferred distance between positively charged collector cylinders and negatively charged emitter probe is 0.7 inches.

To avoid electrical arcing between negatively charged emitter probes (1606, 1705) and grounding plate (1608), the end of negatively charged emitter probes (1606, 1705) that is proximate to the grounding plate (1608) should be sufficiently distant from the grounding plate (1608) to prevent arcing.

During the filtration process, the electrostatic filtration apparatus may be monitored by electronics assembly (1503) which may control fluid pump (1509) and the characteristics of the electrostatic field created between positively charged collector cylinder (1605, 1704) and negatively charged emitter probe (1606, 1705). In various embodiments, electronic assembly (1503) may also monitor pressure/vacuum of the apparatus, water content of the target dielectric liquid, detect leaks, particle count (contamination), power supply output voltage and current, target dielectric liquid temperature, and liquid flow rate through the apparatus. Such sensory data may be utilized by electronics assembly (1503) to communicate run characteristics of the apparatus locally and/or remotely, by virtue of a Modbus or similar communication protocol, to the user for predictive analysis or other purposes.

In some embodiments, the electronic assembly may include controller circuitry, software, and communication circuitry to transmit data received by the controller circuitry and software to a remote computer for analysis and monitoring.

In some embodiments, particulate sensor (1510) may be used as a means of predictive maintenance by alerting the operator about spikes in contamination of the target dielectric liquid which may indicate that issues have developed in the external system that uses the target dielectric liquid.

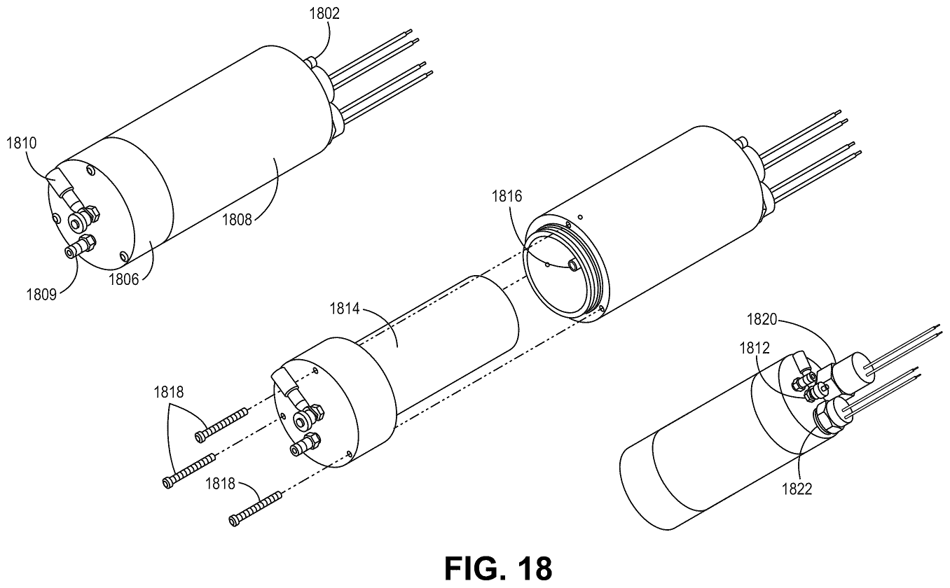

FIG. 18 includes multiple views of an example embodiment of an example filtration assembly. It should be understood that the example filtration assembly can be used in an electrostatic filtration apparatus such as that shown in FIG. 15. The embodiment in FIG. 18 includes fluid inlet (1802), fluid outlet (1809), machined anode side shell (1808), machined cathode side shell (1806), cathode terminal (1810), anode terminal (1812) anode rod (1816), cathode shell (1814), screws (1818), pressure switch (1820), and temperature switch (1822). Anode rod (1816) and cathode shell (1814) can be created using any conductive material such as, e.g. aluminum.

In an exemplary operation, a target dielectric liquid enters the filtration assembly in a continuous flow via the fluid inlet (1802). The dielectric liquid flows into positively charged cathode shell (1814). Within cathode shell (1814), the large electric potential gradient between the cathode shell (1814) and anode rod (1816) creates a strong electrostatic field. The electrostatic field negatively charges electrically conductive contaminant particles within the dielectric liquid flow, which are then attracted to cathode shell (1814) with the assistance of the electrostatic field. Upon contact with cathode shell (1814), the negatively charged contaminant particles may attach to the cathode shell (1814) whereby the contaminant particle is eliminated from the dielectric liquid flow. In this way, electrically conductive contaminants may be removed at the molecular level from a dielectric liquid flow.

Embodiments of the invention may also include a pressure switch and a temperature switch. Exemplary versions of these are depicted in FIG. 18 as pressure switch (1820), and temperature switch (1822). These switches can be used as safety features, and can be used to stop the functioning of the filtration system or any pump if the pressure or temperature in the system exceeds a preset amount.

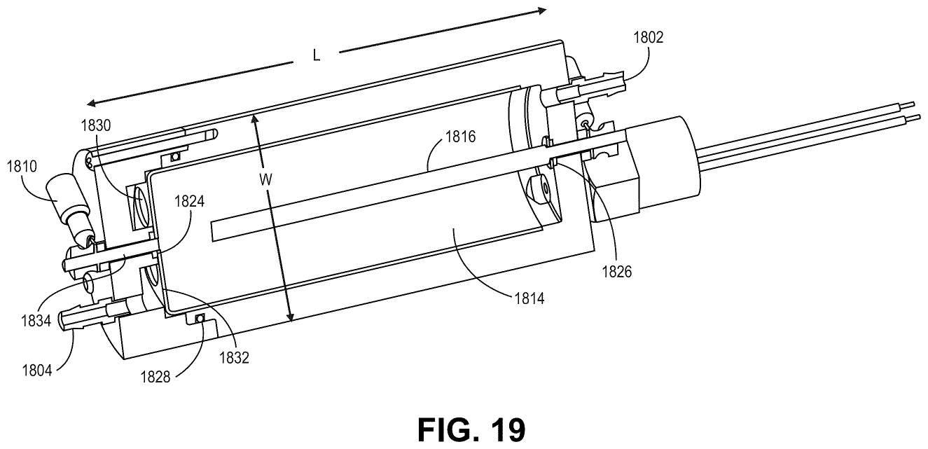

FIG. 19 is a cross-sectional view of an example embodiment of the filtration assembly shown in FIG. 18. This example embodiment includes filtration inlet (1802), fluid outlet (1804), cathode terminal (1810), cathode connection (1834), o-ring seal (1828) sealing machined shells (1806, 1808), sealing washers (1824, 1826), cathode shell (1814), anode rod (1816), fluid passthrough (1830), and grounding plate (1832). Cathode connection (1834) is connected to high voltage electrostatic generator, allowing the high voltage electrostatic generator to charge cathode shell (1814) in the manner described above. Anode rod (1816) is also connected to a high voltage electrostatic generator, allowing the high voltage electrostatic generator to negatively charge anode rod (1816).

In an exemplary operation, a target dielectric liquid enters the filtration assembly through fluid inlet (1802), and flows into cathode shell (1814) where it passes through an electrostatic field generated by the large electric potential gradient between cathode shell (1814) and anode rod (1816). The electrostatic field filters contaminants from the dielectric liquid in the manner described above. The fluid then passes through the fluid passthrough 1830 in grounding plate 1832 before exiting the filtration assembly through fluid outlet (1804).

To create a strong electrostatic field within cathode shell (1814), and thereby ensure effective filtration of conductive contaminants, the radial distance between the interior surface of cathode shell (1814) and the outer surface of anode rod (1816) can be maintained at about 0.5 inches to 1 inch. A more preferred distance between the interior surface of cathode shell (1814) and the outer surface of anode rod (1816) is about 0.6 to 0.8 inches. The most preferred distance between the interior surface of cathode shell (1814) and the outer surface of anode rod (1816) is 0.7 inches.

The exemplary filtration assembly depicted in FIG. 19 has a length L and a width W. This length L and width W can vary based on the volume of fluid to be filtered, the pressure of fluid flow in the system, and any special confines that may dictate specific size constraints. In one preferred embodiment, the length L is between 8″ and 12″, and the width W is between 2″ and 3″. In a particularly preferred embodiment, the length L is 8″ and the width W is 2″.

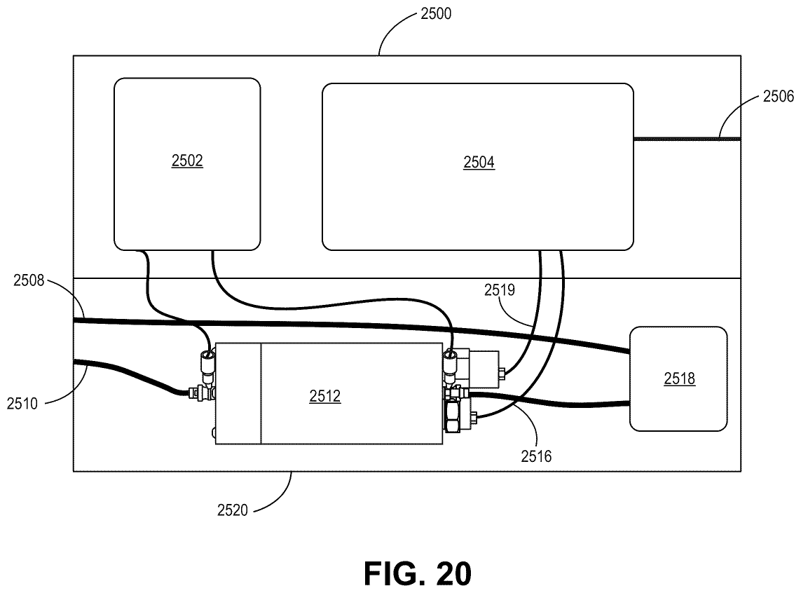

FIG. 20 shows an exemplary electrostatic filtration apparatus that can include a filtration assembly (2512) such as that shown in FIG. 18 and FIG. 19. The electrostatic filtration apparatus includes high voltage power supply (2502), electrical controls (2504), power input (2506), pump (2518), fluid input (2508), fluid output (2510), pressure input (2519), and temperature input (2516). Each of these components can be contained within a two-part enclosure (2500, 2520). Electrical enclosure portion (2500) can contain the electrical controls (2504) and the high voltage power supply (2502). Electrical enclosure portion may be sealed to an ingress protection rating, which would separate it from the fluid enclosure portion (2520).

In an exemplary operation, a dielectric fluid would be caused to flow through fluid input (2508) by pump (2518) into filtration assembly (2512). High voltage power supply (2502) would provide power to the filtration assembly (2512) which would remove contaminants as discussed above. Electrical controls can be used to sense and control a variety of inputs or outputs for the system. For example, the electrical control can set or control the current, voltage, and run time for the system. They can also be used to measure the atmospheric humidity, filter life, pressure, and level of lubricant cleanliness. In some embodiments, the electrical controls can use the measured variables in order to provide particular run settings such as current, voltage, and/or run time. After the dielectric fluid flows through filtration assembly (2512) it would flow out fluid output (2510).

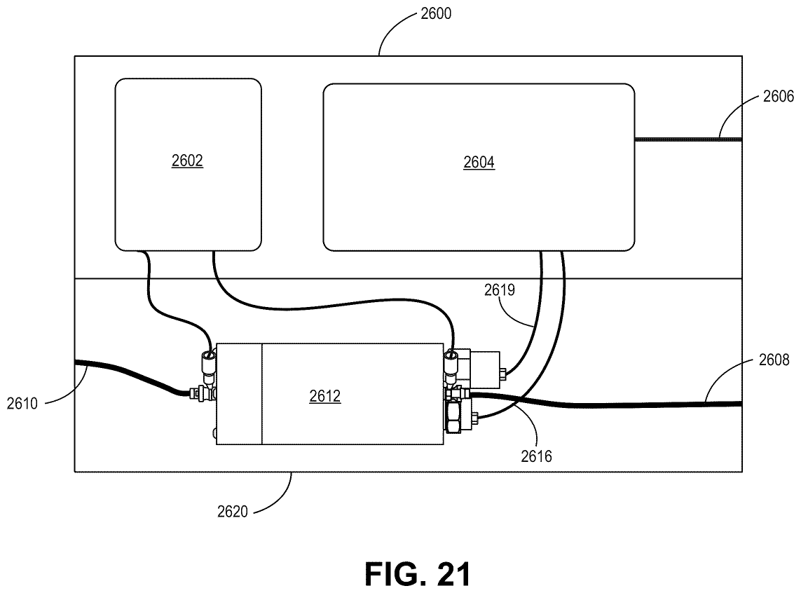

FIG. 21 shows an additional exemplary electrostatic filtration apparatus that does not include a pump. This exemplary electrostatic filtration apparatus includes high voltage power supply (2602), electrical controls (2604), power input (2606), fluid input (2608), fluid output (2610), pressure input (2619), and temperature input (2616). The exemplary system shown in FIG. 21 functions similarly to the system shown in FIG. 20, except that the dielectric fluid flows through the system as a result of external pressure rather than a pump. In this embodiment, there would typically be a pressure regulator which controls the flow rate of the dielectric fluid through the system.

In various embodiments, a non-conductive housing of the filtration assembly may take a number of shapes including being substantially cylindrical, cuboidal, etc.

In various embodiments, the filtration assembly may be oriented differently relative to the other components of the electrostatic filtration apparatus and/or the ground.

The number of volts provided by the high voltage power supply based on the needs of the particular operation. In some cases, a very high voltage such as 15,000 volts will be appropriate in order to maximize the filtration efficacy of the system. In other systems, lower voltage settings may be applicable to preserve power, increase safety, and decrease the risk of a system short. In those cases, the high voltage power supply could provide a high voltage significantly lower than 15,000 volts, including for example down to 500 volts.

The present disclosure can be scaled, both up and down, to achieve greater or lesser throughput of a target dielectric liquid by positioning a plurality of positively charged collector cylinders, each with a corresponding negatively charged emitter probe within it, parallel to one another within a large non-conductive housing. In such an embodiment, additional efficiencies may be realized as the exterior surfaces of the positively charged collector cylinders would act as collection surfaces in addition to the interior surfaces of the positively charged collector cylinders.

Based upon the above discussion and illustrations, those skilled in the art will readily recognize that various modifications and changes may be made to the various embodiments without strictly following the exemplary embodiments and applications illustrated and described herein. For example, though the above discussion has been primarily directed to applications related to contaminant filtration from fluids such as those used in hydraulic and lubrication systems, it should be readily apparent to one of skill in the art that such fluid filtration systems as disclosed herein are readily applicable to applications including lubricants used in power plants, marine vessels, cooling systems, data centers, carbon black, agricultural equipment, and manufacturing, including steel and primary metal manufacturing, water and wastewater treatment, injection molding, and chemical production. Such filtration may also be utilized in industries including construction, food and beverage, lumber and wood production, mining and quarry, oilfields, petrochemical, and military applications. Such modifications and applications do not depart from the true spirit and scope of various aspects of the disclosure, including aspects set forth in the claims.

What is claimed is:

1. An electrostatic filtration apparatus comprising:
a fluid inlet;
a fluid outlet;
a fluid pump;
an electronics assembly;
a high voltage electrostatic generator;
an electrical power inlet; and
a filtration assembly, which comprises:
a non-conductive housing;
a filtration inlet;
a filtration outlet;
a collector connection;
a collector cylinder;
an emitter connection;
an emitter probe; and
a grounding plate;
wherein the fluid inlet allows a fluid to flow into the electrostatic filtration apparatus;
the fluid outlet allows a fluid to flow out of the electrostatic filtration apparatus;
the fluid pump is capable of pumping a fluid from the fluid inlet, through the electrostatic filtration apparatus, including the filtration assembly, and out the fluid outlet;
the electronics assembly may monitor and control the operation of the electrostatic filtration apparatus, including, but not limited to, controlling when the fluid inlet and fluid outlet allow fluid to pass through, and the operation of the high voltage electrostatic generator;
the high voltage electrostatic generator is capable of generating electrostatic charges;
the electrical power inlet allows electrical power to flow into the electrostatic filtration apparatus to supply electrical power to the electronics assembly and the high voltage electrostatic generator, as well as any other electrically powered components that may be included in the electrostatic filtration apparatus;
the filtration assembly filters the fluid passing through the electrostatic filtration apparatus;
wherein the non-conductive housing forms the exterior container of the filtration assembly;
the filtration inlet allows a fluid to flow into the filtration assembly;
the filtration outlet allows a fluid to flow out of the filtration assembly;
the collector cylinder is positioned entirely within the non-conductive housing and receives a positive electrostatic charge from the high voltage electrostatic generator via the collector connection, which electrically couples the collector cylinder with the high voltage electrostatic generator;
the emitter probe is positioned within the collector cylinder such that the emitter probe extends along the central axis of the collector cylinder, in parallel with the walls of the collector cylinder, and substantially in the middle of the cross-section of the collector cylinder;
the emitter probe receiving a negative electrostatic charge from the high voltage electrostatic generator via the emitter connection, which electrically couples the collector cylinder with the high voltage electrostatic generator; and
the grounding plate provides an electrical ground.

2. The apparatus of claim 1, wherein the electrostatic filtration apparatus further comprises a pressure switch for measuring pressure within the electrostatic filtration apparatus.

3. The apparatus of claim 1, wherein the electrostatic filtration apparatus further comprises an emergency stop switch which may be manually triggered to stop the operation of the electrostatic filtration apparatus, the flow of fluid through the electrostatic filtration apparatus, or both.

4. The apparatus of claim 1, wherein the electrostatic filtration apparatus further comprises a particulate sensor for monitoring particle count or other measures of contamination of a fluid.

5. The apparatus of claim 1, wherein the electrostatic filtration apparatus further comprises a temperature switch for monitoring the temperature of the electrostatic filtration apparatus, which may be configured to stop the functioning of the electrostatic filtration apparatus if predefined temperatures are exceeded.

6. The apparatus of claim 1, wherein the electrostatic filtration apparatus further comprises a traditional mechanical or membrane filter.

7. The apparatus of claim 1, wherein the filtration assembly is scaled up so that multiple pairs of collector cylinders and emitter probes may be situated within the non-conductive housing to increase throughput of the electrostatic filtration apparatus.

8. The apparatus of claim 1, wherein the collector cylinder and emitter probe maintain a specified radial spacing not greater than 1 inch and not less than 0.5 inches between the interior surface of the collector cylinder and the exterior surface of the emitter probe so as to generate a strong and consistent electrostatic field within the collector cylinder.

9. The apparatus of claim 1, wherein the collector cylinder and emitter probe maintain a specified radial spacing of 0.7 inches between the interior surface of the collector cylinder and the exterior surface of the emitter probe so as to generate the strongest and most consistent electrostatic field possible within the collector cylinder.

10. A method for electrostatically filtering a fluid, whereby an emitter probe carrying a negative electrostatic charge is positioned within a collector cylinder carrying a positive electrostatic charge such that the emitter probe extends along the central axis of the collector cylinder, in parallel with the walls of the collector cylinder, and substantially in the middle of the cross-section of the collector cylinder, to create a strong electrostatic field within the collector cylinder, so that as a non-conductive fluid passes through the collection cylinder, conductive contaminants within the fluid become negatively charged, are attracted to the collection cylinder, and are eliminated from the fluid by attaching to the collection cylinder.

11. The method of claim 10, wherein the collector cylinder and emitter probe maintain a specified radial spacing not greater than 1 inch and not less than 0.5 inches between the interior surface of the collector cylinder and the exterior surface of the emitter probe so as to generate a strong and consistent electrostatic field within the collector cylinder.

12. The method of claim 10, wherein the collector cylinder and emitter probe maintain a specified radial spacing of 0.7 inches between the interior surface of the collector cylinder and the exterior surface of the emitter probe so as to generate the strongest and most consistent electrostatic field possible within the collector cylinder.
